(19) United States
(12) Patent Application Publication
(10) Pub. No.: US 2022/0061362 A1
(43) Pub. Date: Mar. 3, 2022

(54) BREADED AND SOUS VIDE CHICKEN PRODUCT DESIGN AND MANUFACTURING PROCESS

(71) Applicant: OSI Industries, LLC, Aurora, IL (US)

(72) Inventors: Chuhan Kuei, Naperville (US); Sarah Sutherland, Naperville (US); Kyle Borkovec, Brookfield (US)

(21) Appl. No.: 17/410,151

(22) Filed: Aug. 24, 2021

Related U.S. Application Data
(60) Provisional application No. 63/070,077, filed on Aug. 25, 2020.

(51) Int. Cl. A23L 5/10; A23L 5/30

(52) U.S. Cl. CPC A23L 5/13; A23L 5/30

(57) ABSTRACT

A sous vide cooking process for cooking raw protein pieces stacked on top of one another in a pouch and exposing the pouch to heated water or steam for an effective period to form fully-cooked protein pieces that can be easily separated. The process includes breading the protein pieces and vacuum sealing the breaded protein pieces in a film.

### CROSS-REFERENCE TO RELATED APPLICATIONS

The present invention claims priority to and the benefit of U.S. Provisional Patent Application No. 63/070,077 filed Aug. 25, 2020, the contents of which are incorporated herein by reference and made a part hereof.

### FEDERALLY SPONSORED RESEARCH OR DEVELOPMENT

N/A

### FIELD OF THE INVENTION

A sous vide process for cooking dry coated protein pieces in a pouch, in water or steam, to provide fully cooked protein pieces that are easily separated.

### DESCRIPTION OF THE PRIOR ART

There are numerous methods of cooking protein pieces such as is disclosed in U.S. Pat. Nos. 10,506,822 and 10,292,409 where protein pieces are coated with flour and batter and are thermoformed into a pouch and are cooked in hot water.

However, such prior processes were limited to a single serving per package. This increases the costs for providing protein pieces to large dining establishments that use a lot of product (both in terms of packaging time and materials, and time spent unpacking the protein pieces).

The present invention provides a process for packaging multiple pieces of protein pieces that easily separate without the need for dividers or frying of the protein prior to packaging.

### SUMMARY OF THE INVENTION

The present invention provides a sous vide cooking process for cooking raw protein pieces stacked on top of one another in a pouch and exposing the pouch to heated water or steam to form fully-cooked protein pieces that can be easily separated. The protein pieces can be, for example, chicken, beef or pork. The process may also work for other proteins.

In accordance with one aspect of the invention, a sous vide cooking process for cooking a plurality of raw protein pieces in a single package is provided. The process comprises applying a dry coating, such as a dry breading coating to each of the plurality of protein pieces and placing the plurality of protein pieces into a package in multiple layers after the application of the dry breading coating to each of the plurality of protein pieces. The process also includes vacuum sealing the package, cooking the plurality of protein pieces in the package, and chilling the plurality of protein pieces in the package after cooking the plurality of protein pieces in the package.

In addition to forming the protein pieces in multiple layers, the process can include stacking the plurality of protein pieces on top of one another in a plurality of columns in the package. In particular, the process can include stacking six of the plurality of protein pieces in each of the plurality of columns.

The step of placing the plurality of protein pieces into a package in multiple layers can include placing the plurality of protein pieces in three layers or four layers. Additionally, more layers may also work with the process.

The process can include other steps such as marinating the plurality of protein pieces prior to the step of applying a dry breading coating to each of the plurality of protein pieces. This can be done by tumbling, blending or massaging the plurality of protein pieces with a brine. Additionally, the process can include adding a dry seasoning to the plurality of protein pieces after the step of tumbling, blending or massaging the plurality of protein pieces with a brine.

The process can also include applying a water and dry breading coating to the plurality of protein pieces after the step of applying a dry breading coating to each of the plurality of protein pieces if more breading is desired.

The step of cooking the plurality of protein pieces in the package can comprise exposing the package of the plurality of protein pieces to a heated water or steam for an effective period to form fully-cooked protein pieces that can be easily separated.

In accordance with another aspect of the invention, a sous vide cooking process for cooking a plurality of raw protein pieces is provided. The cooking process comprises marinating a plurality of protein pieces in a brine and transferring the plurality of protein pieces to a breading applicator. The process further comprises applying a dry breading coating to the plurality of protein pieces, transferring the plurality of protein pieces to a packaging machine and placing the plurality of protein pieces in a package in a plurality of layers. The process also comprises vacuum sealing the package, cooking the plurality of protein pieces in the package; and chilling the plurality of protein pieces in the package.

The step of placing the plurality of protein pieces in a package in a plurality of layers can include stacking each of the plurality of protein pieces on top of one another in the package in a plurality of columns.

The protein pieces can be chicken breast fillets, or other proteins such as beef, pork or seafood.

Other features and advantages of the invention will be apparent from the following specification taken in conjunction with the following Figures.

### BRIEF DESCRIPTION OF THE DRAWINGS

To understand the present invention, it will now be described by way of example, with reference to the accompanying drawings in which:

FIG. 1 is a perspective view of a plurality of raw chicken breast fillets;

FIG. 2 is a perspective view of the plurality of chicken breast fillets being marinated with a brine in a tumbler;

FIG. 3 is a perspective view of the chicken breast fillets after being marinated in a container;

FIG. 4 is a perspective view of a manual breading process of the chicken breast fillets;

FIG. 5 is a perspective view of a packaging machine for vacuum sealing a plurality of chicken breast fillets in a thin film;

FIGS. 6-7 are perspective views of a plurality of breaded chicken breast fillets exiting the packaging machine;

FIGS. 8-9 are perspective top and bottom views of packages containing multiple layers of breaded chicken breast fillets;

FIG. 10 is a perspective view of a package of a plurality of layers and columns of chicken breast fillets that have been cooked and chilled; and,

FIG. 11 is a perspective view of a plurality of separated chicken breast fillets from the package of FIG. 10.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a sous vide cooking process for cooking raw protein pieces stacked on top of one another in a pouch and exposing the pouch to heated water or steam for an effective period to form fully-cooked protein pieces that can be easily separated.

The present invention is directed to a sous vide process of cooking a plurality of pieces of protein together in a single vacuum packed package and easily separating the pieces of protein without using special techniques (such as plastic film or paper between layers, frying prior to packaging, etc.). Moreover, the process produces a protein having a “natural” profile, and not a flat or boring profile that was produced by prior processes. In particular, the process is particularly used for chicken fillets.

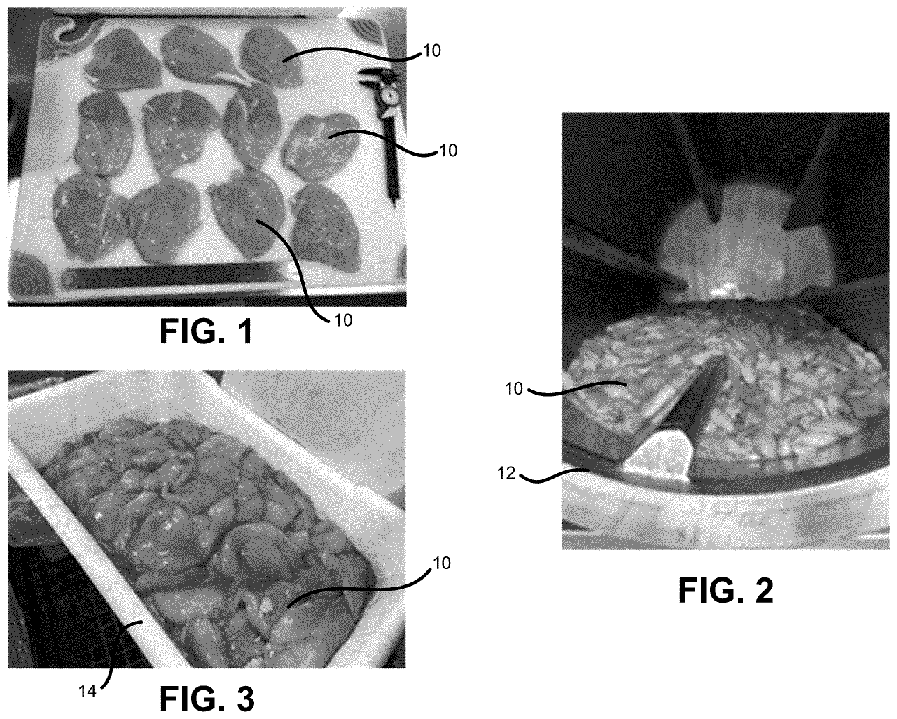

In accordance with an embodiment of the invention, a plurality of raw protein pieces 10, such as a chicken breast fillet, are subjected to a marinating process in a brine (i.e., a seasoning solution). A plurality of untreated, boneless, skinless chicken breasts 10 are shown in FIG. 1.

The chicken breast fillets 10 are marinated by tumbling, massaging or blending the chicken breast fillets 10 with the brine. An additional dry topical seasoning can be added to the chicken breast fillets 10 during or subsequent to this marinating step. A tumbler, massager or a blender, or other similar equipment, can be used for the marinating step.

In accord with one aspect of the invention, the chicken breast fillets 10 and the brine solution are added to a tumbler 12 and then tumbled (e.g., at 4 rpm for 10 minutes). If desired, a vacuum can be applied the chicken breast fillets 10 in the tumbler 12 (preferably to a minimum of 20 in Hg.). FIG. 2 shows the breast fillets 10 inside the marinating tumbler 12. After being marinated, the chicken breast fillets 10 are removed from the tumbler 12. FIG. 3 shows the marinated chicken breast fillets 10 unloaded from the tumbler 12 into a container 14 after the marinating process.

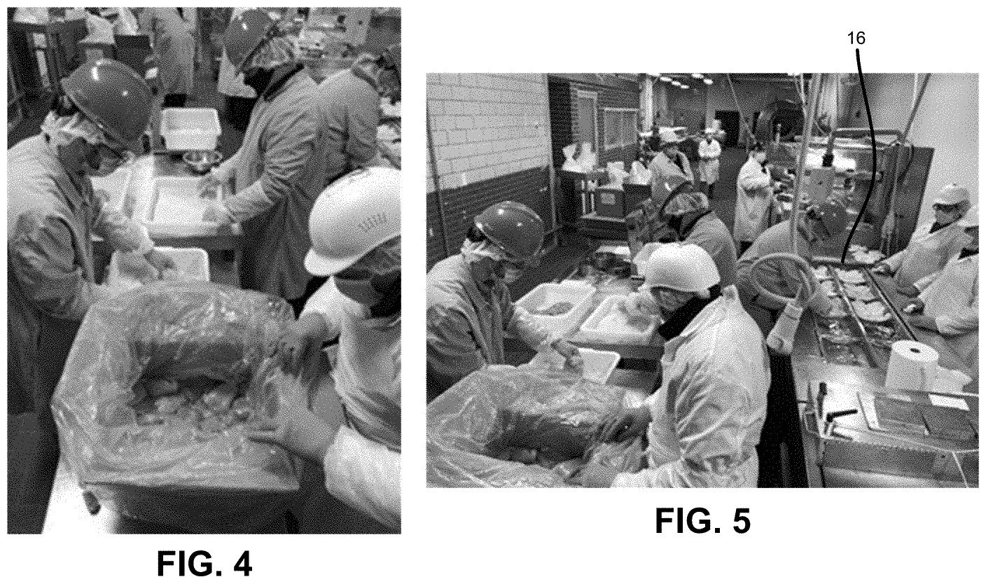

Following the marinating step, the chicken breast fillets 10 are placed flat on a layout belt and transferred to a breading applicator (not shown) for applying a dry breading coating to the surface of the chicken breast fillets 10. A typical breading comprises flour, protein (wheat, dairy or egg), leavening agents, binder, seasoning and flavors, etc. The breading pickup in this operation is about 2-10%. In accordance with another aspect of the invention, the breading can be applied by hand (i.e., manually) as illustrated in FIG. 4.

In an optional step, water, in the form of a mist, water fall or water drip can be applied to the surface of the chicken breast fillets 10 on the layout belt. The chicken breast fillets 10 are then run through another breading applicator. The breading and water pickup in this operation is typically greater than 10%. This step can be repeated multiple times until a desired amount of breading is achieved.

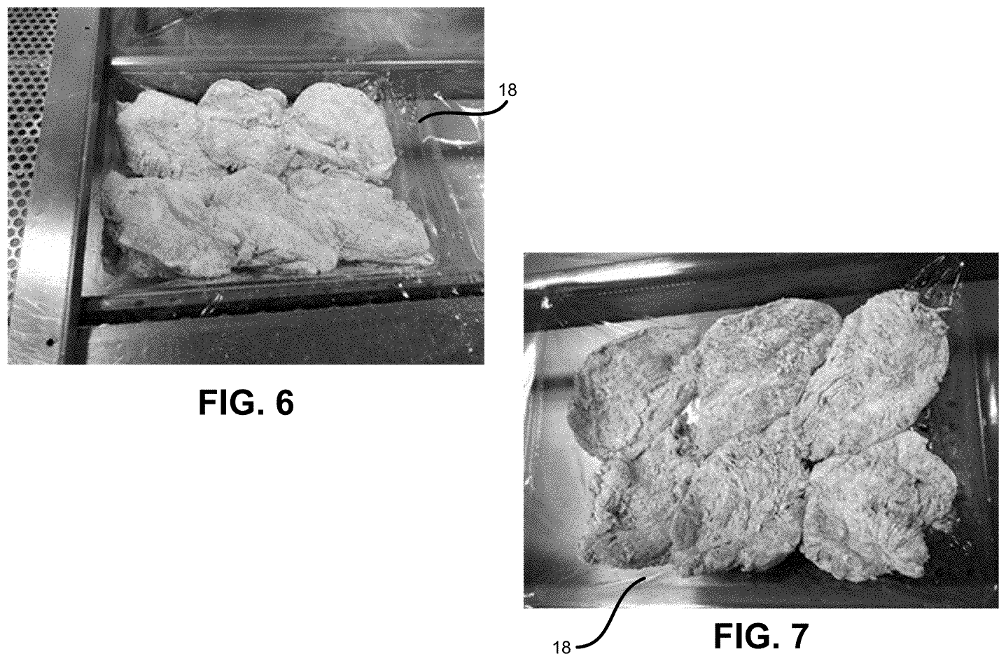

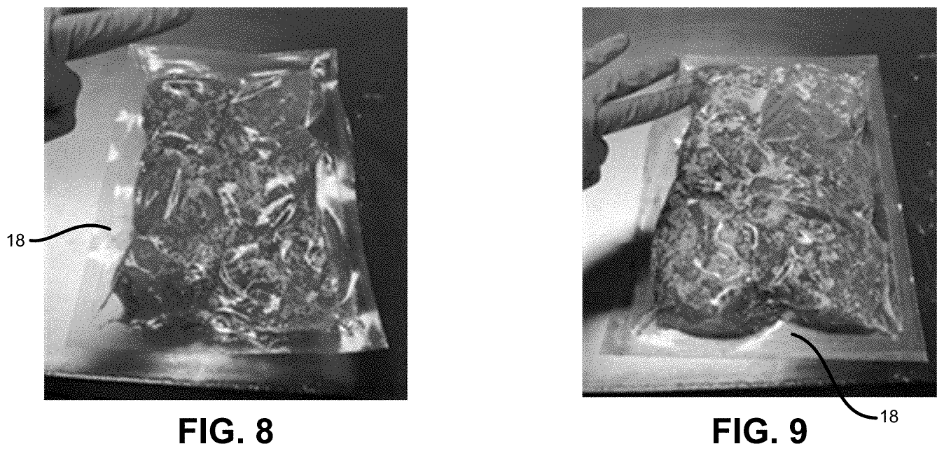

The marinated and breaded chicken breast fillets 10 are then transferred to a packaging machine 16 as shown in FIGS. 5-9. The chicken breast fillets 10 are vacuumed sealed in a clear thin film which forms a package 18. As shown in FIGS. 6 and 7, the chicken breast fillets 10 are packed in multiple layers (i.e., three layers), abutting or slightly overlapping one another. It has been found that both three layers of chicken breast fillets 10 or four layers of chicken breast fillets 10 perform well under this process, however, more or less layers may also work.

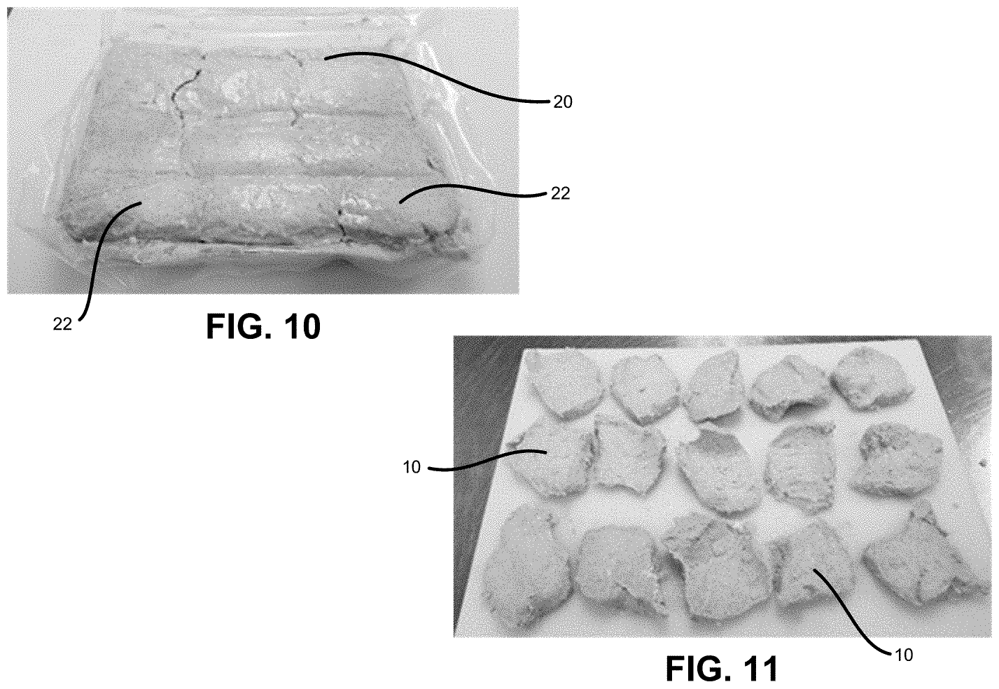

FIG. 10 shows a package 20 of three layers of chicken breast fillets 10. The fillets 10 are column stacked in the layers with a plurality of fillets 10 in each column. FIG. 11 shows the cooked fillets 10 separated after being removed from the package 20.

After being vacuumed sealed, the chicken breast fillets 10 are cooked in a water or steam bath while in the thin film package 18. The package 18 is then chilled and ready for transport (e.g., to a restaurant or other dining facility). When reheated or thawed, and removed from the package, the chicken breast fillets 10 processed in accordance with the described method easily separate from each other because the breading acts like a barrier to prevent chicken pieces from “gluing” together. Instead, the fillets 10 remain intact without the need for any type of separators employed between each fillet 10. Moreover, this is also accomplished without the need for frying the fillets 10 prior to packaging.

The process of including multiple chicken breast fillets 10 in a package will prevent uniform film shrinkage and deliver a more natural and random appearance to the fillets 10.

Many modifications and variations of the present invention are possible in light of the above teachings. It is, therefore, to be understood within the scope of the appended claims the invention may be protected otherwise than as specifically described.

We claim:

1. A sous vide cooking process for cooking a plurality of raw protein pieces comprising:
applying a dry breading coating to each of the plurality of protein pieces;
placing the plurality of protein pieces into a package in multiple layers after the application of the dry breading coating to each of the plurality of protein pieces;
vacuum sealing the package;
cooking the plurality of protein pieces in the package; and,
chilling the plurality of protein pieces in the package after cooking the plurality of protein pieces in the package.

2. The process of claim 1 wherein the step of placing the plurality of protein pieces into a package in multiple layers after the application of the dry breading coating to each of the plurality of protein pieces comprises:
stacking the plurality of protein pieces on top of one another in a plurality of columns in the package.

3. The process of claim 1 wherein the step of stacking each of the plurality of protein pieces on top of one another in the package comprises:
stacking six of the plurality of protein pieces in each of the plurality of columns.

4. The process of claim 1 wherein the step of placing the plurality of protein pieces into a package in multiple layers after the application of the dry breading coating to each of the plurality of protein pieces comprises:
placing the plurality of protein pieces in three layers.

5. The process of claim 1 wherein the step of placing the plurality of protein pieces into a package in multiple layers after the application of the dry breading coating to each of the plurality of protein pieces comprises:
placing the plurality of protein pieces in four layers.

6. The process of claim 2 further comprising the step of:
marinating the plurality of protein pieces prior to the step of applying a dry breading coating to each of the plurality of protein pieces.

7. The process of claim 6 wherein the step of marinating the plurality of protein pieces prior to the step of applying a dry breading coating to each of the plurality of protein pieces comprises:
blending the plurality of protein pieces with a brine.

8. The process of claim 7 further comprising:
adding a dry seasoning to the plurality of protein pieces after the step of blending the plurality of protein pieces with a brine.

9. The process of claim 6 wherein the step of marinating the plurality of protein pieces prior to the step of applying a dry breading coating to each of the plurality of protein pieces comprises:
tumbling the plurality of protein pieces with a brine.

10. The process of claim 6 wherein the step of marinating the plurality of protein pieces prior to the step of applying a dry breading coating to each of the plurality of protein pieces comprises:
massaging the plurality of protein pieces with a brine.

11. The process of claim 1 further comprising:
applying a water and dry breading coating to the plurality of protein pieces after the step of applying a dry breading coating to each of the plurality of protein pieces.

12. The process of claim 1 wherein the plurality of protein pieces are chicken fillets.

13. The process of claim 1 wherein the step of cooking the plurality of protein pieces in the package comprises:
exposing the package of the plurality of protein pieces to a heated water for an effective period to form fully-cooked protein pieces that can be easily separated.

14. The process of claim 1 wherein the step of cooking the plurality of protein pieces in the package comprises:
exposing the package of the plurality of protein pieces to a heated steam for an effective period to form fully-cooked protein pieces that can be easily separated.

15. A sous vide cooking process for cooking a plurality of raw protein pieces comprising:
marinating a plurality of protein pieces in a brine;
transferring the plurality of protein pieces to a breading applicator;
applying a dry breading coating to the plurality of protein pieces;
transferring the plurality of protein pieces to a packaging machine;
placing the plurality of protein pieces in a package in a plurality of layers;
vacuum sealing the package;
cooking the plurality of protein pieces in the package; and, chilling the plurality of protein pieces in the package.

16. The process of claim 15 wherein the step of placing the plurality of protein pieces in a package in a plurality of layers comprises:
stacking each of the plurality of protein pieces on top of one another in the package

17. The process of claim 16 wherein the step of stacking each of the plurality of protein pieces on top of one another in the package comprises:
stacking the plurality of protein pieces in a plurality of columns.

18. The process of claim 15 wherein the step of placing the plurality of protein pieces in a package in a plurality of layers comprises:
placing the plurality of protein pieces in three layers.

19. The process of claim 15 wherein the step of placing the plurality of protein pieces in a package in a plurality of layers placing the plurality of protein pieces in four layers.

20. The process of claim 15 wherein the plurality of protein pieces are formed from chicken.
